(19) United States
(12) Patent Application Publication
(10) Pub. No.: US 2025/0181642 A1
(43) Pub. Date: Jun. 5, 2025

(54) APPARATUS AND METHODS OF USE FOR INDEX KEY GENERATION FOR IDENTIFIERS CONTAINING METADATA ELEMENTS

(71) Applicant: Porter Lee, Inc., Schaumburg, IL (US)

(72) Inventor: Timothy Smith, Rolling Meadows, IL (US)

(21) Appl. No.: 18/528,243

(22) Filed: Dec. 4, 2023

(51) Int. Cl. G06F 16/901; G06F 16/907

(52) U.S. Cl. CPC G06F 16/901; G06F 16/907

(57) ABSTRACT

The invention relates to creating unique identifiers for indexing, sorting, and searching on multiple-part alpha numeric information. The information can be in a database, spreadsheet, or printed on materials that need to be manually placed in order.

### BACKGROUND

The present invention generally relates to a method and apparatus for sorting and searching multiple-part alphanumeric information by data by creating unique identifiers for the information, which allows for a user to more easily search and locate their desired file in a database.

A standard order is often called ascending because it corresponds to the standard order of numbers ascending, i.e., A to Z or 0 to 9. The current state of the art requires using custom index formulas or accepting the potential of improper identifier orders. Another method requires separate entry fields during data input to break down the numbers into parts. These parts are then padded and indexed or placed into multiple data columns for sorting using compound indexes.

The current means for sorting through this type of data requires comparison logic for each section. The first step of that process is that a section is analyzed to see if it is a character section or a numeric section. If it is a character section, then spaces are added at the end to match the length of the longest section. If it is a numeric section, then zeros are added at the beginning to match the length of the longest section. The second step is a lexical comparison is performed. If the sections are equal, then the program will move onto the next section and repeat the first step. If the sections are different, the comparison result determines the order of the identifiers.

The disadvantages of these current products are that padding numbers and text will fail when the sections exceed the length of the padding, that arbitrary padding sizes wastes database space, that existing sorting can produce an ordered list but it doesn't create a unique persistent identifier for indexing, that it requires recomputing the data for each comparison, that searching for the identifier may fail if it includes additional padding, and that there is no method to logically place specific items into a custom position in the list.

### SUMMARY OF THE INVENTION

Provided herein are methods and apparatuses for creating unique identifiers for indexing sorting and searching on multiple-part alphanumeric information.

The methods and apparatuses are set forth in part in the description which follows, and in part will be obvious from the description, or can be learned by practice of the methods and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1 is an example of the invention generating identifiers using data that would be commonly used at a police department

FIG. 2a is a list of escapes for special identifiers and prefix characters arranged to allow forcing positions, a list of section escapes prefixes, and an outline of a special identifier.

FIG. 2b is a list of identifiers in a random order and a simple lexical order with the problems encountered by these database sort methods.

FIG. 2c is an example of the present invention compared to an existing method that uses a padding mask. The problem encounter by the use of the padding mask are also listed.

FIG. 3 is an example of the invention generating identifiers and then sorting them, showing how the present disclosure is able to better sort this information in the order a user would want it to be in.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The words proximal and distal are applied herein to denote specific ends of components of the instrument described herein. A proximal end refers to the end of an instrument nearer to an operator of the instrument when the instrument is being used. A distal end refers to the end of a component further from the operator and extending towards the surgical area of a patient and/or the implant.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to the arrangement of steps or operational flow, plain meaning derived from grammatical organization or punctuation, or the number or type of aspects described in the specification.

### DESCRIPTION OF EMBODIMENTS

This process works by using a deterministic process that will create unique compound lexical identifiers from regular identifiers that contain multiple parts including metadata. These identifiers can then be lexically sorted into a human natural order, used for storing computer compound indexes into a single compressed index. Additionally, the identifier can be used in a binary search through a set of identifiers with multiple sections and can be used to manually sort and find items. The disclosure uses identifiers with leading zeros and various length sections are automatically handled for sorting in a natural order and well as for searching.

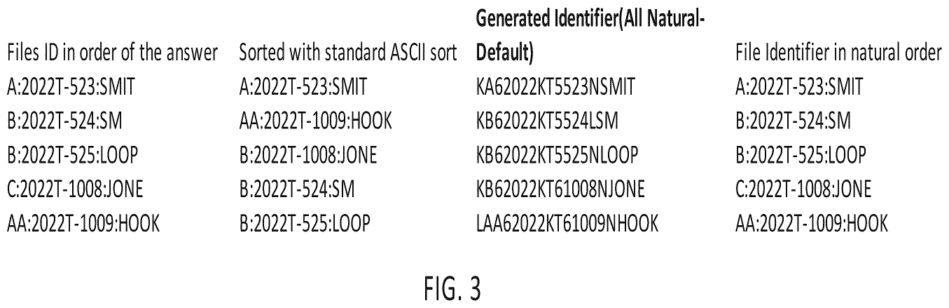

The best use of the disclosure is when it is used in a system where identifiers are provided by outside systems. It is also useful when the identifier contains many pieces of metadata. An example of the disclosure being used with identifiers provided by outside systems can be found in FIG. 3.

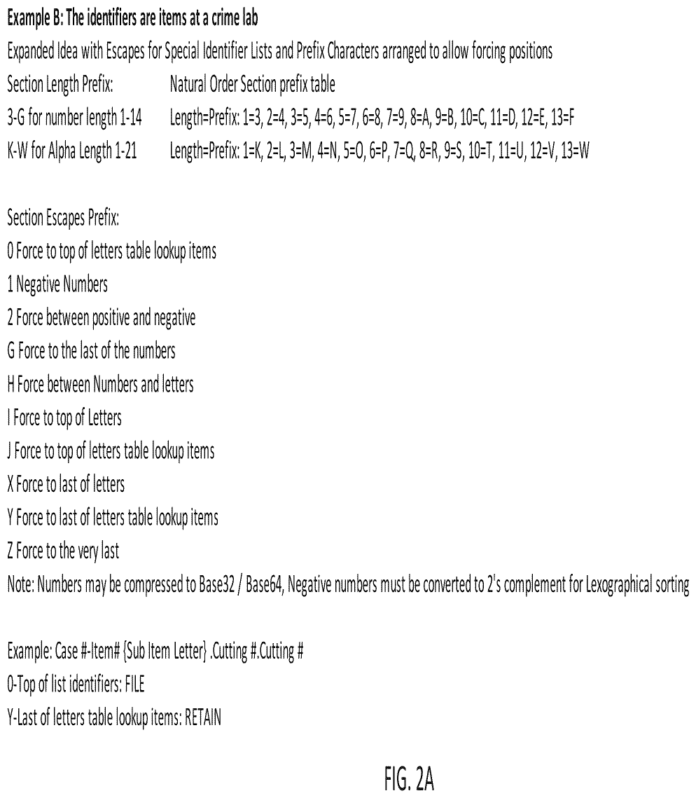

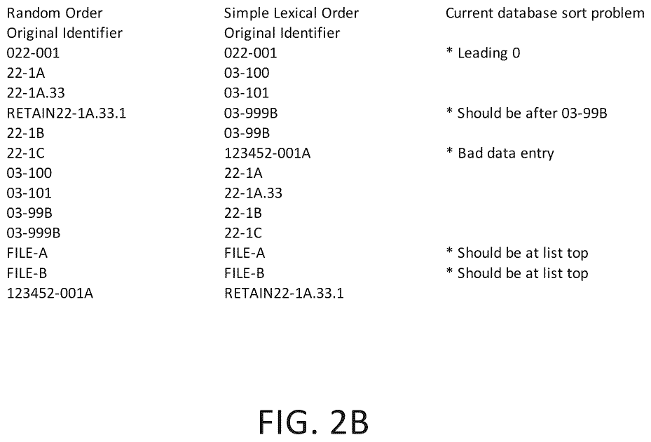

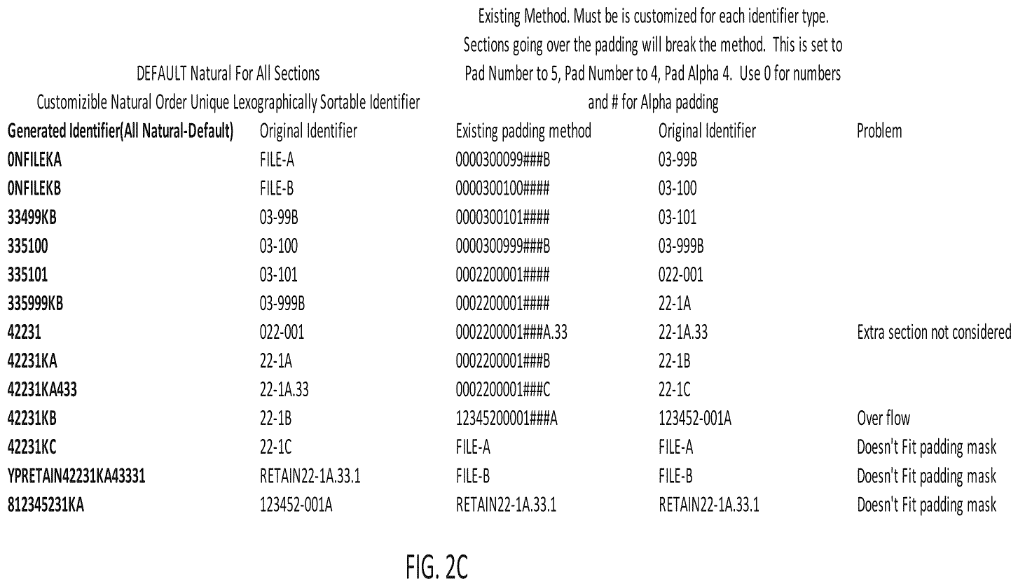

One embodiment of how this invention works can be shown in FIGS. 2A-2C. Here the section length prefix is defined as 3-G for the number length 1-14 and K-W for Alpha length 1-21. Additionally, the Natural Order Section Prefix table is defined as length=prefix. It is further defined as numerically 1=3, 2=4, 3=5, 4-6, 5=7, 6-8, 7=9, 8=A, 9=B, 10=c, 11=D, 12=E, 13=F, and alphabetically 1=K, 2=L, 3=M, 4=N, 5-0, 6=P, 7=Q, 8=R, 9=S, 10-T, 11=U, 12=V, 13=W. It then uses designated characters known as section escape prefixes to indicate how the identifier should be treated within the context of sorting or indexing. Escape prefixes that are use in one particular embodiment are 0 for force to top of letter table lookup items; 1 for negative number; 2 for force between positive and negative; G for force to the last of the numbers; H for force between numbers and letters; I for force to top of letters; J for force to top of letters table lookup items; X for force to last of letters; Y for force to last of letters table lookup items; and Z for force to the very last. Numbers used in this iteration may be compressed to Base32/Base64 and negative numbers must be converted to 2's in order to complement Lexographical sorting. When an identifier is run through this program it creates a unique identifier that is able to be retained in the user's preferred order, does not create unnecessary padding, and allows for every character to be considered. This embodiment is advantageous over the current methods of creating and indexing identifiers because identifiers with leading zeros and various length sections are automatically handled for sorting in a natural order and well as for searching.

The use of the present invention will make database indexing multi-part identifiers simple and foolproof. It will allows for the index to be naturally ordered in different sections with Numbers and Alpha chars handled. The deterministic identifier can be used for searching. It allows for custom ordering for special identifiers which would allow the user to make the important information appear at the top of the list. It works no matter how long the Identifier sections are and they can be expanded over time. This avoids the indexing scheme form becoming obsolete. The method of use has the ability to be expanded without invalidating existing Identifiers. Additionally, the present invention allows for variations using regular expressions.

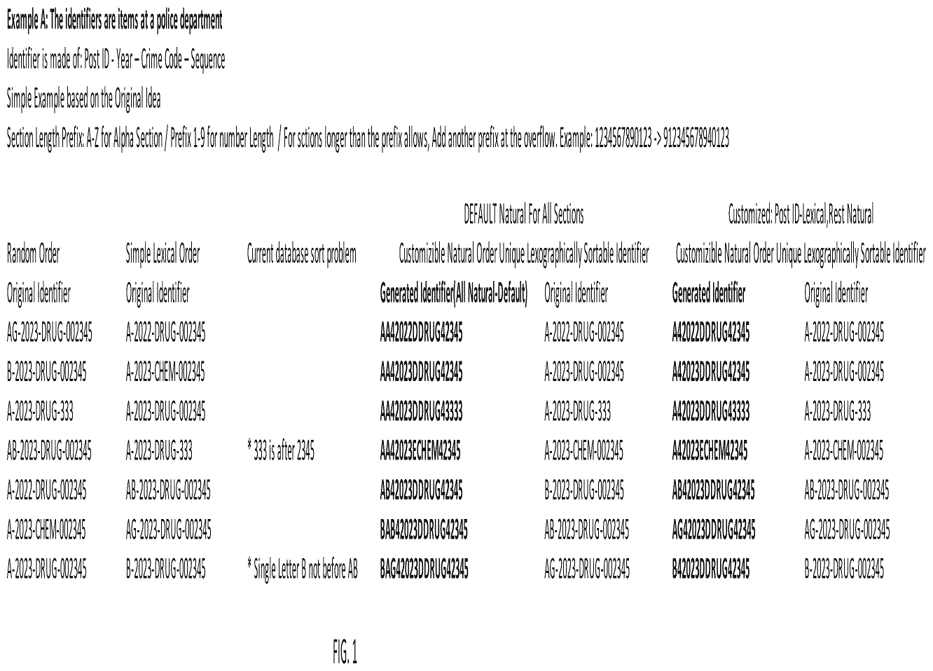

FIG. 1 shows a simple example of one embodiment of the invention where Identifiers are indexed and sorted in four different ways, Random order, Simple Lexical Order, Default Natural for all sections, and Customized: Post ID-Lexical, Rest Natural. As shown in figure one, the problem with the simple lexical ordering is that identifiers are not organized the way that humans would typically organize them. The two sections titled DEFAULT Natural For All Sections and Customized: Post ID-Lexical, Rest Natural show how an embodiment of the invention can organize the identifiers by adding in unique characters.

FIG. 2a shows one embodiment of the invention where escapes for special identifier lists and prefix characters arranged to allow forcing positions are given. The section length prefix is defined as 3-G for the number length 1-14 and K-W for Alpha length 1-21. This is further defined in the Natural Order Section Prefix table is defined as length=prefix: 1=3, 2=4, 3=5, 4-6, 5=7, 6=8, 7=9, 8=A, 9=B, 10-C, 11=D, 12=E, and 13=F for the number length. For the alpha length it is defined as length=prefix: 1=K, 2=L, 3=M, 4=N, 5=0, 6=P, 7-Q, 8=R, 9=S, 10-T, 11=U, 12=V, and 13=W. It then uses designated characters known as section escape prefixes to indicate how the identifier should be treated within the context of sorting or indexing. Escape prefixes that are use in one particular embodiment are 0 for force to top of letter table lookup items; 1 for negative number; 2 for force between positive and negative; G for force to the last of the numbers; H for force between numbers and letters; I for force to top of letters; J for force to top of letters table lookup items; X for force to last of letters; Y for force to last of letters table lookup items; and Z for force to the very last. Numbers used in this iteration may be compressed to Base32/Base64 and negative numbers must be converted to 2's in order to complement Lexographical sorting.

FIG. 2b shows a random order for the list of original identifiers and a simple lexical order for the original identifiers. The problems with the simple lexical order are also listed. These include 0's being leading, 03-999B being before 03-99B when it should be after, 123452-001A being listed in the middle of the list which is bad data entry, and identifiers FILE-A and FILE-B being near the bottom of the list when they should be at the top of the list.

FIG. 2c shows the group of identifiers that was displayed in FIG. 2b, with the first list being one that was created using the parameters that were listed in FIG. 2a, and the second list being the existing method for customizing and sorting identifiers and the problems therein. These problems include, the extra section in 22-1A.33 not being considered, 123452-001A's identifier having overflow, and the identifiers FILE-A, FILE-B, AND RETAIN22-1A.33.1 not fitting the padding mask. These problems as well the as the ones listed in FIG. 2a are solved by using this embodiment of the present invention.

FIG. 3 shows an example of the present invention where it is able to create unique identifiers for the five file IDs and keep them in the order that the user would want them to be in. The first list of File ID's show the order in which the user of the file cabinet would want them to appear in. The next list shows the files sorted using a standard ASCII (American Standard Code for Information Interchange) sort and problems encountered in the current method. These problems ac that AA should be at the end but is instead listed between the A and B folders. Additionally, the 1008 file appears before the 524 and 525 files when it should appear after those files. The next list shown is the file list that is generated by the present invention. Using this embodiment, the original order of the index is maintained.

### Examples

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

### System

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1. A method of using index key generation for identifiers containing metadata elements, comprising the steps:
Creating lexical identifier keys from natural identifiers and sorting the natural identifiers in a sort order; using the lexical identifier keys as an index to maintain the sort order; using a computer readable medium to sort lexicographic order; increasing the accuracy of searching the lexicographic order with the natural identifiers;
breaking the natural identifiers into alpha, numbers, and separators; adding a prefix to the identifier based on the portion being a number of Alpha and putting the prefixed identifiers back together.

2. The method of claim 1, where the lexical identifier keys contain meta data.

3. The method of claim 2, where the lexical identifier keys can be used for storing computer compound indexes into a single compressed index.

4. The method of claim 3, where the lexical identifier keys are used in a binary search through a set of identifiers with multiple sections.

5. The method of claim 3, where the lexical identifier keys are used to manually sort and find items.

6. The method of claim 3, where the lexical identifier keys are used for displaying records in a natural order.
